(19) United States
(12) Patent Application Publication
(10) Pub. No.: US 2023/0009483 A1
(43) Pub. Date: Jan. 12, 2023

(54) MEASUREMENT CONTROL DEVICE

(71) Applicant: DENSO CORPORATION, Kariya-city (JP)

(72) Inventors: Taichi WATANABE, Kariya-city (JP); Hiroyuki AKUZAWA, Kariya-city (JP); Amane HIGASHI, Kariya-city (JP)

(21) Appl. No.: 17/944,562

(22) Filed: Sep. 14, 2022

Related U.S. Application Data
(63) Continuation of application No. PCT/JP2021/010051, filed on Mar. 12, 2021.

(30) Foreign Application Priority Data
Mar. 17, 2020 (JP) 2020-046430

(51) Int. Cl. G01F 15/02; F02M 35/10

(52) U.S. Cl. CPC G01F 15/022; F02M 35/10386

(57) ABSTRACT

A measurement control device includes a sensing unit and a low-pass filter unit. The sensing unit outputs an air flow rate value corresponding to an air flow rate flowing through a flow path. The low-pass filter unit removes high-frequency components included in the air flow rate value input from the sensing unit. The measurement control device calculates a pulsation state that is a state of a pulsation occurring in the air flow rate based on the air flow rate value that has passed through the low-pass filter unit. The measurement control device corrects the air flow rate value using the pulsation state.

### CROSS REFERENCE TO RELATED APPLICATIONS

The present application is a continuation application of International Patent Application Ser. No. PCT/JP2021/010051 filed on Mar. 12, 2021, which designated the U.S. and claims the benefit of priority from Japanese Patent Application No. 2020-046430 filed on Mar. 17, 2020. The entire disclosures of all of the above applications are incorporated herein by reference.

### TECHNICAL FIELD

The present disclosure relates to a measurement control device.

### BACKGROUND

A device for measuring a flow rate of air sucked into an engine, which is an internal combustion engine, has been proposed.

### SUMMARY

The present disclosure provides a measurement control device that includes a sensing unit and a low-pass filter unit. The sensing unit outputs an air flow rate value corresponding to an air flow rate flowing through a flow path. The low-pass filter unit removes high-frequency components included in the air flow rate value input from the sensing unit. The measurement control device calculates a pulsation state that is a state of a pulsation occurring in the air flow rate based on the air flow rate value that has passed through the low-pass filter unit. The measurement control device corrects the air flow rate value using the pulsation state.

### BRIEF DESCRIPTION OF DRAWINGS

The features and advantages of the present disclosure will become more apparent from the following detailed description made with reference to the accompanying drawings. In the drawings:

FIG. 1 is a perspective view of an airflow meter according to a first embodiment as viewed from an upstream outer surface side.

FIG. 2 is a perspective view of the airflow meter as viewed from a downstream outer surface side.

FIG. 3 is a vertical cross-sectional view of the airflow meter in a state in which the airflow meter is attached to an intake pipe.

FIG. 4 is a cross-sectional view taken along a line IV-IV of FIG. 3.

FIG. 5 is a cross-sectional view taken along a line V-V in FIG. 3.

FIG. 6 is a block diagram showing a schematic configuration of the airflow meter.

FIG. 7 is a block diagram showing a schematic configuration of a correction circuit.

FIG. 8 is a diagram showing a detection flow rate and a response compensation flow rate with respect to time in a response compensation unit.

FIG. 9 is a diagram for explaining a method of calculating an upper extreme interval.

FIG. 10 is a diagram for explaining a method of calculating an average air amount.

FIG. 11 is a diagram for explaining a method of calculating a pulsation amplitude.

FIG. 12 is a diagram for explaining an example of calculating an output value after correction by correcting an output value before correction with a correction amount.

FIG. 13 is a diagram for exemplifying noise included in an output value.

FIG. 14 is a diagram showing a configuration of a disturbance removal filter unit.

FIG. 15 is a diagram showing a configuration of a secondary low-pass filter with a more simplified disturbance removal filter unit.

FIG. 16 is a diagram showing input/output characteristics of the secondary low-pass filter shown in FIG. 15.

FIG. 17 shows a relationship between an input waveform and an output waveform of a primary low-pass filter as a comparative example, and a relationship between an input waveform and an output waveform of the secondary low-pass filter shown in FIG. 15.

FIG. 18 is a diagram showing frequency characteristics of the primary low-pass filter as the comparative example and the secondary low-pass filter shown in FIG. 15.

FIG. 19 is a diagram showing frequency characteristics of the disturbance removal filter unit when a pulsation frequency is low and when a pulsation frequency is high.

FIG. 20 is a diagram showing a relationship between an engine speed and a cutoff frequency of the disturbance removal filter unit.

FIG. 21 is a diagram showing a relationship between the pulsation frequency and a sum of feedback coefficients of the disturbance removal filter unit.

FIG. 22 is a block diagram showing a schematic configuration of a correction circuit according to a second embodiment.

FIG. 23 is a diagram for explaining calculation of a lower extreme interval.

FIG. 24 is a diagram for explaining average value processing of the frequency calculation unit.

FIG. 25 is a diagram for explaining median processing of the frequency calculation unit.

FIG. 26 is a diagram for explaining a frequency limiting function of the frequency calculation unit.

### DETAILED DESCRIPTION

For example, a device for measuring a flow rate of air sucked into an engine may include a flow rate detection unit that detects a detection flow rate that is an output corresponding to the air flow rate, which is the flow rate of air, and a filter that removes high-frequency harmonic components included in the output signal of the flow rate detection unit. In addition, the device may include a pulsation cycle calculation unit that calculates a pulsation cycle in the detection flow rate based on the signal that has passed through the filter, a pulsation amplitude calculation unit that calculates a pulsation amplitude in the detection flow rate, and an average flow rate calculation unit that calculates an average flow rate that is an average of detection flow rates.

Furthermore, this device may include a correction value calculation unit that calculates a pulsation correction value based on the pulsation amplitude, the pulsation cycle, and the average flow rate, and an error correction unit that corrects the detection flow rate detected by the flow rate detection unit using the pulsation correction value calculated by the correction value calculation unit.

In the device, a moving average filter that outputs an average of input signal values for a predetermined period in the past while shifting the present time is used as the filter. However, according to the inventor's study, such a moving average filter cannot sufficiently remove high-order harmonic components such as second-order harmonics and third-order harmonics included in the output signal of the flow rate detection unit. Therefore, the measurement accuracy of the air flow rate deteriorates.

Alternatively, for example, it is conceivable to use a primary low-pass filter as the filter. However, even when a primary low-pass filter is adopted, it is not possible to sufficiently remove high-order harmonic components having a higher frequency than a fundamental wave included in the output signal of the flow rate detection unit. Further, when the primary low-pass filter is adopted, the fundamental wave included in the output signal of the flow rate detection unit is greatly attenuated as compared with a case where a secondary low-pass filter is adopted. In particular, when a pulsation is low, the fundamental wave of the output signal of the flow rate detection unit is greatly attenuated, so the air flow rate cannot be detected with high accuracy, and the measurement accuracy of the air flow rate deteriorates.

The present disclosure provides a measurement control device that improve a measurement accuracy of an air flow rate.

An exemplary embodiment of the present disclosure provides a measurement control device that includes a sensing unit, a low-pass filter unit, a pulsation state calculation unit, and a flow rate correction unit. The sensing unit outputs an air flow rate value corresponding to an air flow rate flowing through a flow path. The low-pass filter unit removes high-frequency components included in the air flow rate value input from the sensing unit. The pulsation state calculation unit calculates a pulsation state that is a state of a pulsation occurring in the air flow rate based on the air flow rate value that has passed through the low-pass filter unit. The flow rate correction unit corrects the air flow rate value using the pulsation state calculated by the pulsation state calculation unit. The low-pass filter unit includes a high-order recursive low-pass filter that includes a plurality of delay blocks and an adder. The plurality of delay blocks delays an output signal output from the low-pass filter unit by different delay amounts. The adder adds signals output from the plurality of delay blocks to the air flow rate value corresponding to the air flow rate input from the sensing unit by performing a feedback of the signals output from the plurality of delay blocks.

In the exemplary embodiment of the present disclosure, the low-pass filter unit includes the high-order recursive low-pass filter that includes the plurality of delay blocks and the adder. Therefore, high-order harmonic components can be sufficiently removed, the attenuation of the fundamental wave output from the sensing unit can be reduced, and the measurement accuracy of the air flow rate can be improved.

Hereinafter, a plurality of embodiments of the present disclosure will be described with reference to the drawings. The same reference numerals are assigned to the corresponding elements in each embodiment, and thus, duplicate descriptions may be omitted. When configurations are described only partly in the respective embodiments, the configurations of the embodiments previously described may be applied to the rest of the configurations. Further, not only the combinations of the configurations explicitly shown in the description of the respective embodiments, but also the configurations of the plurality of embodiments can be partially combined even when they are not explicitly shown as long as there is no difficulty in the combination in particular. Unspecified combinations of the configurations described in the plurality of embodiments and the modification examples are also disclosed in the following description.

### First Embodiment

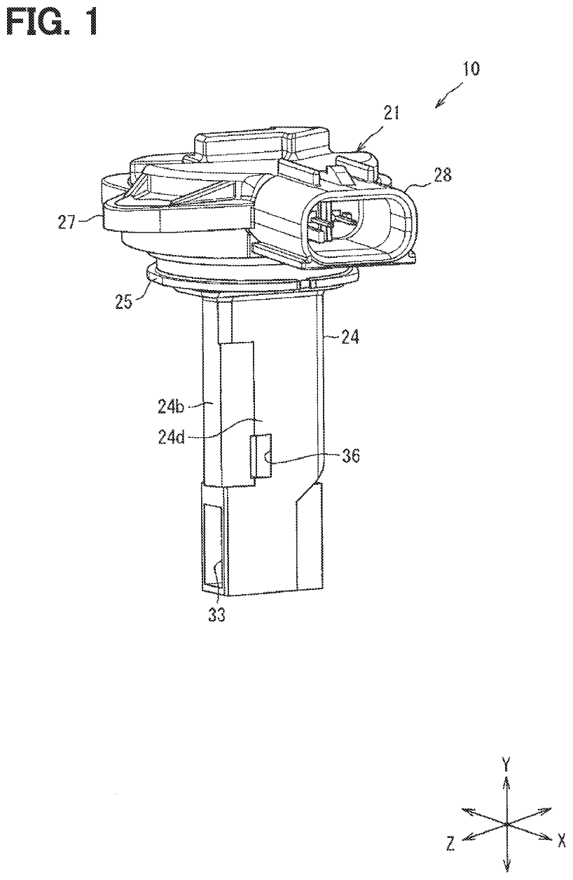

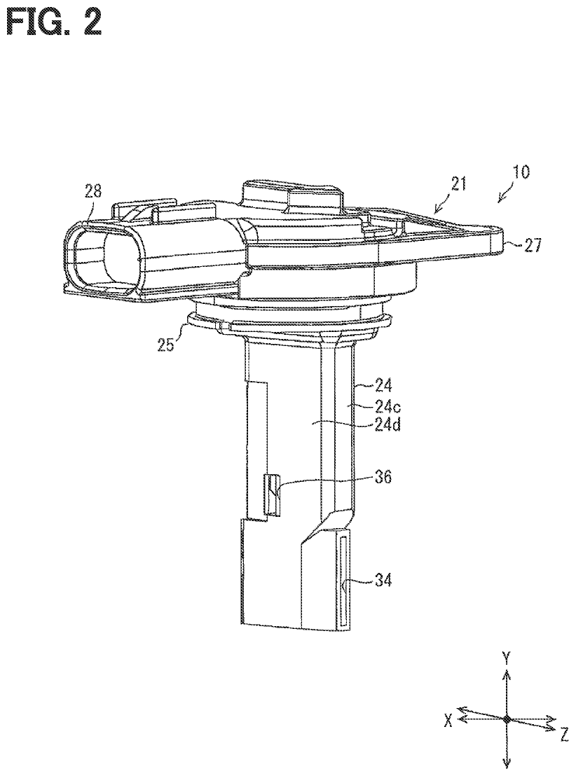

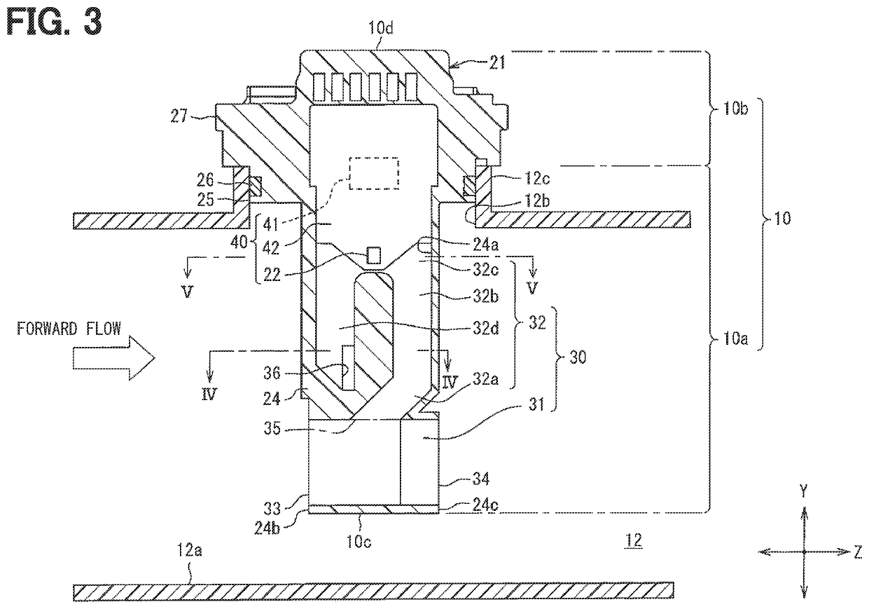

An airflow meter 10 shown in FIGS. 1 and 2 is included in a combustion system having an internal combustion engine such as a gasoline engine. The combustion system is mounted on a vehicle. As shown in FIG. 3, the airflow meter 10 is provided in an intake passage 12 for supplying an intake air to the internal combustion engine in a combustion system, and measures a physical quantity such as a flow rate, a temperature, a humidity, and a pressure of a gas such as the intake air or a fluid such as a gas flowing through the intake passage 12. In that case, the airflow meter 10 corresponds to a flow measurement device.

The airflow meter 10 is attached to an intake pipe 12a such as an intake duct that forms the intake passage 12. The intake pipe 12a is provided with an airflow insertion hole 12b as a through hole penetrating through an outer peripheral portion of the intake pipe 12a. An annular pipe flange 12c is attached to the airflow insertion hole 12b, and the pipe flange 12c is included in the intake pipe 12a. The airflow meter 10 is inserted into the pipe flange 12c and the airflow insertion hole 12b to enter the intake passage 12, and is fixed to the intake pipe 12a and the pipe flange 12c in this state.

In the present embodiment, a width direction X, a height direction Y, and a depth direction Z of the airflow meter 10 are orthogonal to each other. The airflow meter 10 extends in the height direction Y, and the intake passage 12 extends in the depth direction Z. The airflow meter 10 includes an inward unit 10a positioned in the intake passage 12 and an outward unit 10b protruding outward from the pipe flange 12c without being in the intake passage 12, and the inward unit 10a and the outward unit 10b are aligned in the height direction Y. In the airflow meter 10, one of a pair of end surfaces 10c and 10d and included in the inward unit 10a is referred to as an airflow tip end face 10c, and the other end surface included in the outward unit 10b is referred to as an airflow base end face 10d. In that case, the airflow tip end face 10c and the airflow base end face 10d are aligned in the height direction Y. The airflow tip end face 10c and the airflow base end face 10d are orthogonal to the height direction Y. Further, the tip end surface of the pipe flange 12c is also orthogonal to the height direction Y.

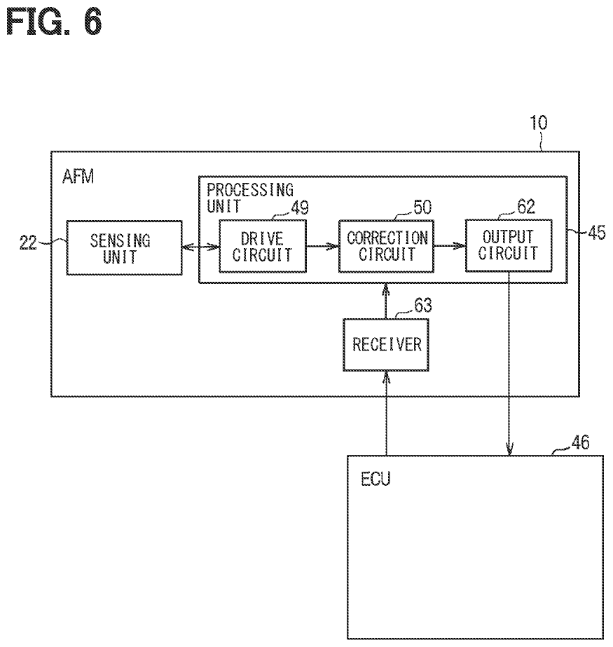

As shown in FIGS. 1 and 2, the airflow meter 10 has a housing 21, and a sensing unit 22 for detecting a flow rate of an intake air (see FIGS. 3 and 6). The sensing unit 22 is provided in an internal space 24a of a housing body 24. The housing 21 is made of, for example, a resin material or the like. In the airflow meter 10, the housing 21 is attached to the intake pipe 12a so that the sensing unit 22 is brought into contact with the intake air flowing through the intake passage 12. The housing 21 has a housing main body 24, a ring holding portion 25, a flange portion 27, and a connector portion 28, and an O-ring 26 (see FIG. 3) is attached to the ring holding portion 25.

The housing main body 24 is formed in a cylindrical shape as a whole, and in the housing 21, the ring holding portion 25, the flange portion 27, and the connector unit 28 are integrally provided in the housing main body 24. The ring holding portion 25 is included in the inward unit 10a, and the flange portion 27 and the connector portion 28 are included in the protruding part 10b.

The ring holding portion 25 is provided inside the pipe flange 12c, and holds the O-ring 26 so as not to be displaced in the height direction Y. The O-ring 26 is a sealing member for sealing the intake passage 12 inside the pipe flange 12c, and is in close contact with both an outer peripheral surface of the ring holding portion 25 and an inner peripheral surface of the pipe flange 12c. A fixing hole such as a screw hole for fixing a fixing tool such as a screw for fixing the airflow meter 10 to the intake pipe 12a is provided in the flange portion 27. The connector portion 28 is a protection portion for protecting a connector terminal electrically connected to the sensing unit 22.

As shown in FIG. 3, the housing main body 24 provides a bypass flow channel 30 through which a part of the intake air flowing through the intake passage 12 flows. The bypass flow channel 30 is disposed in the inward unit 10a of the airflow meter 10. The bypass flow channel 30 has a passage flow channel 31 and a measurement flow channel 32, and the passage flow channel 31 and the measurement flow channel 32 are defined by an internal space 24a of the housing main body 24. The intake passage 12 may be referred to as a main passage, and the bypass flow channel 30 may be referred to as a sub-passage. In FIG. 3, the O-ring 26 is not shown.

The passage flow channel 31 penetrates through the housing main body 24 in the depth direction Z. The passage flow channel 31 has an inflow port 33 as an upstream end portion and an outflow port 34 as a downstream end portion. The inflow port 33 and the outflow port 34 are aligned in the depth direction Z, and the depth direction Z corresponds to an alignment direction. The measurement flow channel 32 is a branch flow channel branched from an intermediate portion of the passage flow channel 31, and the sensing unit 22 is provided in the measurement flow channel 32. The measurement flow channel 32 has a measurement inlet 35 which is an upstream end portion of the measurement flow channel 32 and a measurement outlet 36 which is a downstream end portion of the measurement flow channel 32. A portion where the measurement flow channel 32 branches from the passage flow channel 31 is a boundary between the passage flow channel 31 and the measurement flow channel 32, and the measurement inlet 35 is included in the boundary. The measurement outlet 36 corresponds to a branch outlet.

The sensing unit 22 includes a circuit board and a detection element mounted on the circuit board, and is a chip-type flow sensor. The detection element has a heater unit such as a heating resistor and a temperature detection unit that detects the temperature of the air heated by the heater portion, and the sensing unit 22 outputs an output signal corresponding to the change of the temperature along with the heating in the detection element. The sensing unit 22 can also be referred to as a flow rate detecting unit.

The airflow meter 10 has a sensor sub-assembly including the sensing unit 22, and the sensor sub-assembly is referred to as a sensor SA40. The sensor SA 40 is accommodated in the housing main body 24. In addition to the sensing unit 22, the sensor SA 40 has a circuit chip 41 electrically connected to the sensing unit 22, and a mold unit 42 that protects the sensing unit 22 and the circuit chip 41. The circuit chip 41 has a digital circuit that performs various processes, and is a rectangular parallelepiped chip component. In the sensor SA 40, the sensing unit 22 and the circuit chip 41 are supported by a lead frame, and the circuit chip 41 is electrically connected to the sensing unit 22 and the lead frame via a bonding wire or the like.

The mold unit 42 is a mold resin such as a polymer resin molded by molding, and has higher insulating properties than the lead frame and the bonding wire. The mold unit 42 protects the circuit chip 41 and the sensing unit 22 in a state where the circuit chip 41, the bonding wire, and the like are sealed. In the sensor SA 40, the sensing unit 22 and the circuit chip 41 are mounted in one package by the mold unit 42. Further, the sensor SA40 corresponds to a sensing sub-assembly unit, and the mold unit 42 corresponds to a body. The sensor SA 40 may also be referred to as a detection unit or a sensor unit.

The sensing unit 22 outputs a signal corresponding to the air flow rate in the measurement flow channel 32 to the circuit chip, and the circuit chip calculates the flow rate by using the signal output from the sensing unit 22. The calculation result of the circuit chip is the flow rate of the air measured by the airflow meter 10. An inflow port 33 and an outflow port 34 of the airflow meter 10 are disposed at the center position of the intake passage 12 in the height direction Y. The intake air flowing at the center position of the intake passage 12 in the height direction Y flows along the depth direction Z. A direction in which the intake air flows in the intake passage 12 substantially coincides with a direction in which the intake air flows in the passage flow channel 31. The sensing unit 22 is not limited to a thermal type flow rate sensor, and may be an ultrasonic type flow sensor, a Kalman vortex type flow sensor, or the like.

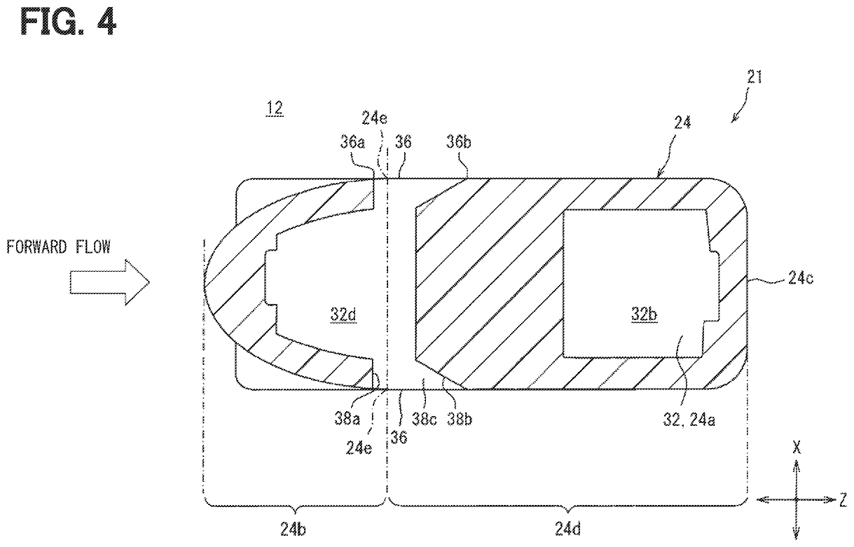

As shown in FIG. 4, an outer peripheral surface of the housing main body 24 forming an outer peripheral surface of the housing 21 has an upstream outer surface 24b, a downstream outer surface 24c, and a pair of intermediate outer surfaces 24d. In the outer peripheral surface of the housing main body 24, the upstream outer surface 24b faces the upstream side of the intake passage 12, and the downstream outer surface 24c faces the downstream side of the intake passage 12. The pair of intermediate outer surfaces 24d face opposite sides in the width direction X, and are flat surfaces extending in the depth direction Z. The upstream outer surface 24b is inclined with respect to the intermediate outer surfaces 24d. In this case, the upstream outer surface 24b is an inclined surface curved so that a width dimension of the housing main body 24 in the width direction X is gradually reduced toward the upstream side in the intake passage 12.

The intermediate outer surfaces 24d are provided between the upstream outer surface 24b and the downstream outer surface 24c in the depth direction Z. In this case, the upstream outer surface 24b and the intermediate outer surface 24d are aligned in the depth direction Z, and the surface boundary 24e, which is a boundary between the upstream outer surface 24b and the intermediate outer surfaces 24d, extends in the height direction Y. The upstream outer surface 24b and the downstream outer surface 24c are a pair of end surfaces facing each other in the depth direction Z.

As shown in FIG. 3, the inflow port 33 is provided on the upstream outer surface 24b, and the outflow port 34 is provided on the downstream outer surface 24c. In this case, the inflow port 33 and the outflow port 34 are opened in opposite directions to each other. As shown in FIG. 4, the measurement outlet 36 is provided on both the upstream outer surface 24b and the intermediate outer surfaces 24d by being disposed at a position extending across the surface boundary 24e in the depth direction Z. In the measurement outlet 36, a portion disposed on the upstream outer surface 24b is opened toward the same side as the inflow port 33, and a portion disposed on the intermediate outer surfaces 24d is opened in the width direction X. In this case, the measurement outlet 36 faces a direction inclined toward the inflow port 33 with respect to the width direction X. In this case, the measurement outlet 36 is not opened toward the outflow port 34. In other words, the measurement outlet 36 is not opened toward the downstream side in the intake passage 12.

The measurement outlet 36 has a longitudinally long flat shape extending along the surface boundary 24e. The measurement outlet 36 is disposed at a position closer to the intermediate outer surfaces 24d with respect to the surface boundary 24e in the depth direction Z. In the measurement outlet 36, an area of a portion disposed on the intermediate outer surfaces 24d is larger than an area of a portion disposed on the upstream outer surface 24b. In this case, in the depth direction Z, a separation distance between the downstream end portion of the measurement outlet 36 and the surface boundary 24e is larger than a separation distance between the upstream end portion of the measurement outlet 36 and the surface boundary 24e.

The inner peripheral surface of the measurement flow channel 32 has defining surfaces 38a to 38c that define the measurement outlet 36. A through hole for defining the measurement outlet 36 is provided in the outer peripheral portion of the housing main body 24, and the defining surfaces 38a to 38c are included in an inner peripheral surface of the through hole. The upstream defining surface 38a of the defining surfaces 38a to 38c forms an upstream end portion 36a of the measurement outlet 36, and the downstream defining surface 38b forms a downstream end portion 36b of the measurement outlet 36. A pair of the connection defining surfaces 38c connect the upstream defining surface 38a and the downstream defining surface 38b, and the pair of the defining surfaces 38c are provided to sandwich the defining surfaces 38a and 38b.

The upstream defining surface 38a is orthogonal to the depth direction Z, and extends in the width direction X from the upstream end portion 36a of the measurement outlet 36 toward the inside of the housing main body 24. The downstream defining surface 38b is inclined with respect to the depth direction Z, and is an inclined surface extending straight toward the upstream outer surface 24b side from the downstream end portion 36b of the measurement outlet 36 toward the inside of the housing main body 24.

A flow of the intake air generated on the outer peripheral side of the housing main body 24 in the intake passage 12 will be described in brief. In the air flowing toward the downstream side of the intake passage 12, an air reaching the upstream outer surface 24b of the housing main body 24 gradually changes a direction of the air while reaching the measurement outlet 36 by advancing along the upstream outer surface 24b which is an inclined surface. As described above, since the direction of the air is smoothly changed by the upstream outer surface 24b, a separation of the air is hardly generated in the vicinity of the measurement outlet 36. For that reason, the air flowing through the measurement flow channel 32 easily flows out of the measurement outlet 36, and the flow velocity in the measurement flow channel 32 easily stabilizes.

Further, the air flowing through the measurement flow channel 32 and flowing out from the measurement outlet 36 to the intake passage 12 flows along the downstream defining surface 38b, which is an inclined surface, so that the air easily flows toward the downstream side in the intake passage 12. In this case, when the air flowing out from the measurement outlet 36 along the downstream defining surface 38b joins the intake air flowing through the intake passage 12, turbulence such as a vortex is less likely to occur, so that the flow velocity of the inside of the measurement flow channel 32 tends to be stable.

As shown in FIG. 3, the measurement flow channel 32 has a folded shape folded back between the measurement inlet 35 and the measurement outlet 36. The measurement flow channel 32 has a branch path 32a branched from the passage flow channel 31, a guide path 32b for guiding the air flowing in from the branch path 32a toward the sensing unit 22, a detection path 32c provided with the sensing unit 22, and a discharge path 32d for discharging the air from the measurement outlet 36. In the measurement flow channel 32, the branch path 32a, the guide path 32b, the detection path 32c, and the discharge path 32d are disposed in this order from the upstream side.

The detection path 32c extends in the depth direction Z so as to be parallel to the passage flow channel 31, and is provided at a position separated from the passage flow channel 31 toward the protruding part 10b. The branch path 32a, the guide path 32b, and the discharge path 32d are provided between the detection path 32c and the passage flow channel 31. The guide path 32b and the discharge path 32d are parallel to each other by extending in the height direction Y from the detection path 32c toward the passage flow channel 31. The branch path 32a is provided between the guide path 32b and the passage flow channel 31, and corresponds to an inclined branch path inclined with respect to the passage flow channel 31. The branch path 32a extends from the measurement inlet 35 toward the outflow port 34 with respect to the depth direction Z, and is a straight flow channel. The discharge path 32d is provided closer to the inflow port 33 than the guide path 32b in the depth direction Z, and extends from the measurement outlet 36 toward the detection path 32c.

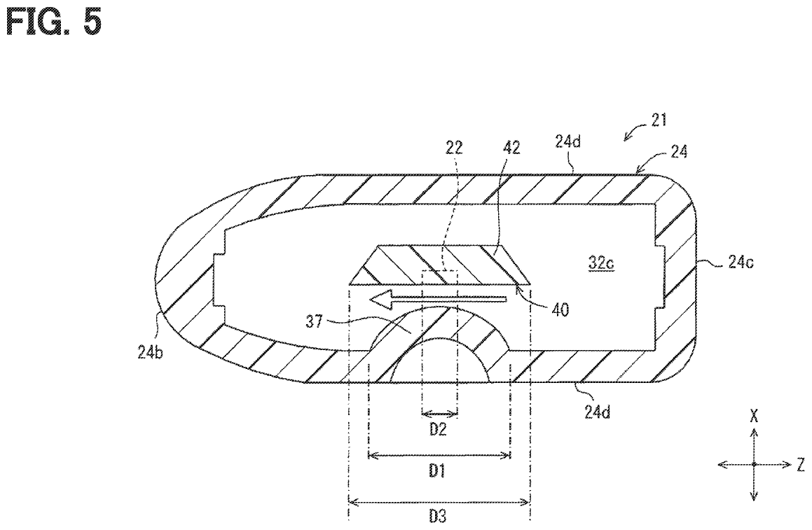

As shown in FIG. 5, the sensor SA 40 is arranged at a position where the sensing unit 22 has entered the detection path 32c. The sensing unit 22 is arranged between the pair of intermediate outer surfaces 24d in the width direction X, and extends in the depth direction Z and the height direction Y. The sensing unit 22 is in a state of partitioning the detection path 32c in the width direction X.

The housing 21 has a detection throttle portion 37 that gradually narrows the detection path 32c toward the sensing unit 22 in the depth direction Z. The detection throttle portion 37 gradually reduces a cross-sectional area of the detection path 32c from an end on the downstream outer surface 24c side toward the sensing unit 22 in the detection path 32c. The detection throttle portion 37 gradually reduces a cross-sectional area of the detection path 32c from an end on the upstream outer surface 24b side toward the sensing unit 22 in the detection path 32c. In the detection path 32c, the cross-sectional area is defined as a cross-sectional area in a direction orthogonal to the depth direction Z. When air is flowing in the forward direction toward the sensing unit 22 in the detection path 32c, the detection throttle portion 37 can adjust the direction of air flow by gradually reducing the detection path 32c. The detection throttle portion 37 corresponds to a rectification mechanism. The detection throttle portion 37 also corresponds to a throttle portion.

The detection throttle portion 37 is provided at a position facing the sensing unit 22 on an inner peripheral surface of the detection path 32c. The detection throttle portion 37 protrudes from an inner peripheral surface of the housing body 24 toward the sensing unit 22, and a depth dimension D1 of the detection throttle portion 37 in the depth direction Z is larger than a depth dimension D2 of the sensing unit 22 in the depth direction Z. In a region where the sensing unit 22 exists in the height direction Y, a depth dimension D3 of the mold unit 42 in the depth direction Z is larger than the depth dimension D1 of the detection throttle portion 37.

The detection throttle portion 37 has a tapered shape in the width direction X. Specifically, a base end portion of the detection throttle portion 37 protruding from the inner wall of the housing main body 24 in the width direction X is the widest portion, and a tip portion of the detection throttle portion 37 is the narrowest portion. The width dimension of the base end portion of the detection throttle portion 37 is set to the depth dimension D1 described above. The detection throttle portion 37 has a curved surface that expands toward the sensing unit 22. The detection throttle portion 37 may have a tapered shape expanded toward the sensing unit 22.

When a surface of the inner peripheral surface of the detection path 32c on the housing tip side is referred to as a bottom surface and a surface on the housing base end side is referred to as a ceiling surface, the bottom surface of the detection path 32c is formed by the housing main body 24, while the ceiling surface is formed by the sensor SA 40. The detection throttle portion 37 extends from the bottom surface of the detection path 32c toward the ceiling surface. The outer peripheral surface of the detection throttle portion 37 extends straight in the height direction Y.

In the detection path 32c, a separation distance between the mold unit 42 and the detection throttle portion 37 gradually decreases while approaching the sensing unit 22 in the depth direction Z. In this configuration, when the intake air flowing from the guide path 32b to the detection path 32c passes between the mold unit 42 and the detection throttle portion 37, the flow velocity of the intake air tends to increase as the air approaches the sensing unit 22. In this case, since the intake air is given to the sensing unit 22 at an appropriate flow rate, the output of the sensing unit 22 tends to be stable, and detection accuracy can be improved.

In the intake passage 12, when pulsations such as intake pulsations or the like occur in a flow of the intake air due to an operation state of the engine or the like, in addition to a forward flow flowing from the upstream side, a backward flow flowing from the downstream side in the backward direction to the forward flow may occur in association with the pulsations. In the intake passage 12, the inflow port 33 is open toward the upstream side, so that a forward flow can easily flow into the inflow port 33. In addition, the oufflow port 34 is open toward the downstream side, and a backward flow easily flows into the oufflow port 34. Further, in the intake passage 12, the measurement outlet 36 is not opened toward the downstream side, and backward flow does not easily flow into the measurement outlet 36. Therefore, even when a backflow flows from the measurement outlet 36, the flow of the backflow to the measurement outlet 36 is not stable, and the air flow rate in the measurement flow channel 32 tends to be unstable.

Unlike the present embodiment, for example, in a configuration in which a part of the outer peripheral surface is a stepped surface facing the downstream side in the housing body 24, and the measurement outlet 36 is formed on this stepped surface, it is conceivable that turbulence such as vortex is likely to occur in the air passing through the stepped surface in the intake passage 12. On the other hand, in the present embodiment, since the measurement outlet 36 is not formed on the stepped surface, the turbulence of the airflow is less likely to occur around the measurement outlet 36, and a case where easiness of the backflow to enter the measurement outlet 36 fluctuates is less likely to occur. As described above, since unstable backflow is unlikely to occur in the measurement flow channel 32, stable pulsation measurement can be achieved in the airflow meter 10.

As shown in FIG. 6, the airflow meter 10 has a processing unit 45 that processes an output signal of the sensing unit 22. The processing unit 45 is provided on the circuit chip 41 and is electrically connected to an Electronic Control Unit (ECU) 46. The ECU 46 corresponds to an internal combustion engine control device, and is an engine control device having a function of controlling the engine based on a measurement signal from the airflow meter 10 and the like. The measurement signal is an electric signal indicating the air flow rate corrected by a pulsation error correction unit 61, which will be described later. One-way communication between the processing unit 45 and the ECU 46 is enabled, and while signals are input from the processing unit 45 to the ECU 46, signals are not input from the ECU 46 to the processing unit 45. The ECU 46 is provided independently of the processing unit 45 and the airflow meter 10, and corresponds to an external device.

The ECU 46 is electrically connected to an engine sensor such as a crank angle sensor and a cam angle sensor. The ECU 46 acquires engine parameters such as a rotation angle, a rotation speed, and rotation number of the engine using the detection signal of the engine sensor, and controls the engine using these engine parameters. The pulsation generated in the intake air in the intake passage 12 correlates with the engine parameters. However, the ECU 46 of the present embodiment does not output the engine parameters to the processing unit 45, and the processing unit 45 does not use the engine parameter when performing processing such as correction for the output signal of the sensing unit 22. The engine parameter corresponds to external information.

The sensing unit 22 outputs an output signal corresponding to the airflow rate flowing through the measurement flow channel 32 to the processing unit 45. The output signal is an electric signal, a sensor signal, or a detection signal output from the sensing unit 22, and an output value corresponding a value of the air flow rate is included in the output signal. The sensing unit 22 can detect the air flow rate for both the air flowing forward in the measurement flow channel 32 from the measurement inlet 35 to the measurement outlet 36 and the air flowing in the backward direction from the measurement outlet 36 toward the measurement inlet 35. The output value of the sensing unit 22 becomes a positive value when the air is flowing in the forward direction in the measurement flow channel 32, and becomes a negative value when the air is flowing in the backward direction in the measurement flow channel 32.

When a pulsation occurs in the airflow in the intake passage 12, the sensing unit 22 is affected by the pulsation, and an error of the true airflow occurs in the output value. In particular, the sensing unit 22 is susceptible to pulsation when a throttle valve is operated to a fully open side. For example, the pulsation amplitude and the pulsation rate are likely to increase when the throttle valve is operated toward the fully open side. Hereinafter, the error due to the pulsation is also referred to as pulsation error Err. The true air flow rate is an air flow rate that is not affected by pulsation. The pulsation rate is a value obtained by dividing the pulsation amplitude by an average value.

The processing unit 45 detects an air flow rate on the basis of an output value of the sensing unit 22, and outputs the detected air flow rate to the ECU 46. The processing unit 45 has a drive circuit 49 that drives the heater unit of the sensing unit 22, a correction circuit 50 that corrects the output value of the sensing unit 22, and an output circuit 62 that outputs a correction result of the correction circuit 50 to the ECU 46. The drive circuit 49 supplies electric power used for driving the heater unit and the like to the sensing unit 22, in addition to drive control of the heater unit. The drive circuit 49 performs preprocessing such as amplifying an output signal of the sensing unit 22 at a stage before the correction circuit 50 performs a correction process.

The processing unit 45 corresponds to a measurement control device that measures the air flow rate. The processing unit 45 includes an arithmetic processing device such as a CPU, and a storage device for storing a program and data. For example, the processing unit 45 is realized by a microcomputer having a storage device readable by a computer. The processing unit 45 calculates an air flow rate by performing various calculations by executing a program stored in the storage device by the arithmetic processing device, and outputs the calculated air flow rate to the ECU 46.

The storage device is a non-transitory tangible storage medium for non-transitory storage of computer readable programs and data. The storage medium is realized by a semiconductor memory or the like. The storage device can also be referred to as a storage medium. The processing unit 45 may include a volatile memory for temporarily storing data.

The processing unit 45 has a function of correcting the output value in which the pulsation error Err occurs. In other words, the processing unit 45 corrects the airflow of the output signal so as to approach the true airflow. Therefore, the processing unit 45 outputs, to the ECU 46, the air flow rate obtained by correcting the pulsation error Err as the measurement signal. The measurement signal includes a measurement value that is a correction result of the output value.

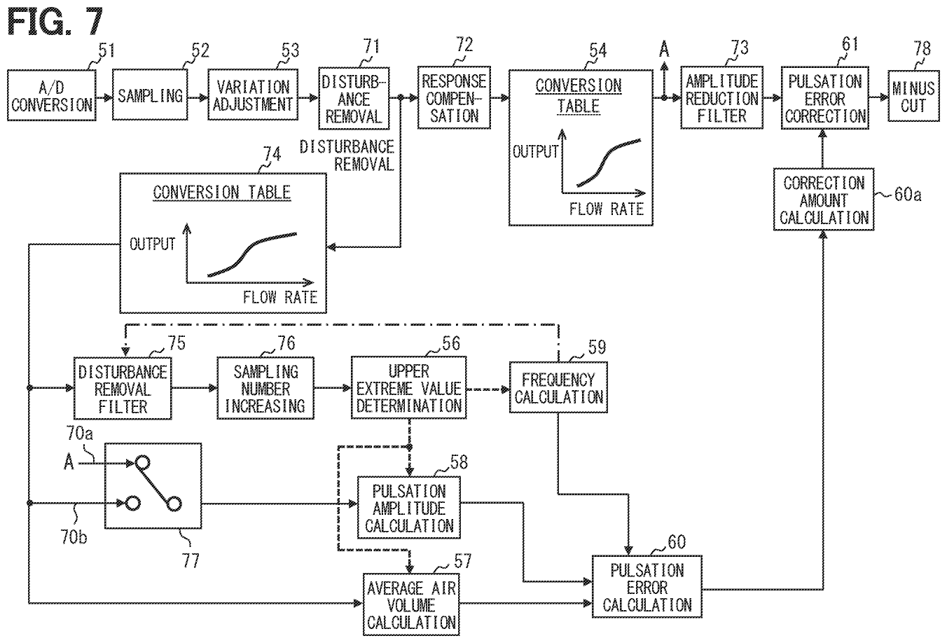

The processing unit 45 operates as multiple functional blocks by executing the program. The drive circuit 49, the correction circuit 50, and the output circuit 62 are all functional blocks. As shown in FIG. 7, the correction circuit 50 includes, as functional blocks, an A/D conversion unit 51, a sampling unit 52, a variation adjustment unit 53, a disturbance removal unit 71, a response compensation unit 72, a first conversion table 54, and an amplitude reduction filter unit 73.

The A/D conversion unit 51 A/D-converts an output value input from the sensing unit 22 to the correction circuit 50 via the drive circuit 49. The sampling unit 52 samples the ND-converted output value at a predetermined sampling interval At, and acquires a sampling value at every timing. These sampling values are included in the output value.

The variation adjustment unit 53 adjusts variations of the output value of the sensing unit 22 so that measurement values do not vary due to individual differences of the airflow meter 10, such as an individual difference of the sensing unit 22. Specifically, the variation adjustment unit 53 reduces individual variations in a flow rate output characteristic indicating the relationship between the output value and the actual air flow rate and a temperature characteristic indicating the relationship between the flow rate output characteristic and the temperature.

The disturbance removal unit 71 is a functional block that is provided between the variation adjustment unit 53 and the response compensation unit 72, and to which an output value processed by the variation adjustment unit 53 is input. The disturbance removal unit 71 is a sudden change limiting unit that limits a sudden change in the output value so large that the rate of change with respect to the output value at previous time exceeds a predetermined reference value, and limits the change amount to a predetermined value, for example.

The response compensation unit 72 is a functional block that is provided between the disturbance removal unit 71 and the first conversion table 54, and to which an output value processed by the disturbance removal unit 71 is input. The response compensation unit 72 is a filter that causes the output value to faithfully reproduce a sudden change in the air flow rate actually detected by the sensing unit 22, and is formed by, for example, a high-pass filter. The response compensation unit 72 advances the phase of the detected flow rate input via the disturbance removal unit 71 to compensate for the response delay of the air flow rate value. That is, the output value compensated by the response compensation unit 72 is in a state where the response is ahead of the output value before compensation. The error in the flow rate is suppressed by the response compensation unit 72.

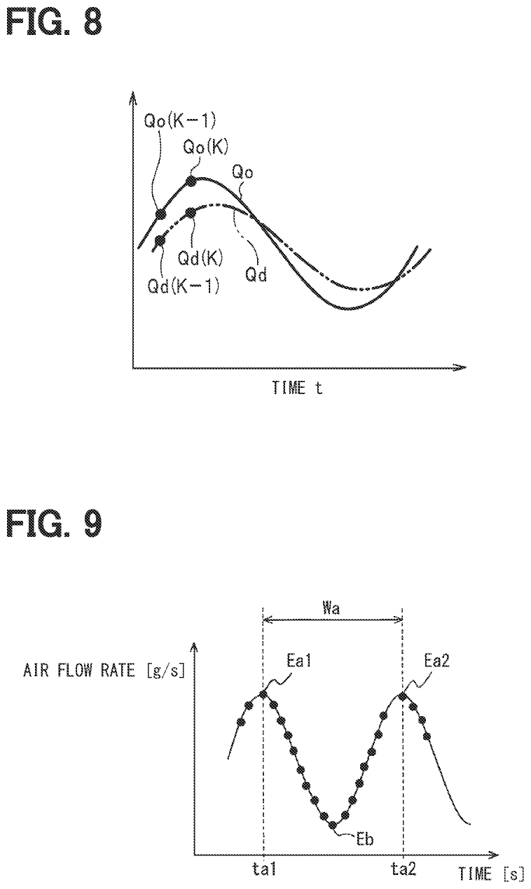

As shown in FIG. 8, the response compensation unit 72 can change a flow rate change amount ΔQd, which is a change amount of the detected flow rate Qd input via the disturbance removal unit 71. The response compensation unit 72 calculates so that the flow rate change amount ΔQd increases, and calculates a response compensation flow rate Qo that is a value obtained by compensating for a response delay of the detected flow rate Qd. In FIG.7, the response compensation flow rate Qo with respect to time t is indicated by a solid line, and the detected flow rate Qd with respect to time t is indicated by a two-dot chain line.

The response compensation unit 72 calculates the flow rate change amount ΔQd using a sampling time interval Δt corresponding to a time change, a time constant τ, and a linear function of the detected flow rate Qd, as shown in the expression (1). Further, the response compensation unit 72 calculates the response compensation flow rate Qo based on the flow rate change amount ΔQd and the detected flow rate Qd. The response compensation unit 72 calculates the response compensation flow rate Qo using the inverse operation with the primary delay. In the expression (1), ΔQd (k) is a change amount corresponding to Qd (k). Qo (k) is a response compensation flow rate Qo corresponding to Qd (k). The time constant τ indicates a response of the sensor, and is an amount that gives a measure of response time of an output to an input. The time constant T may be simply a fixed value, or may be calculated as a function of the detected flow rate Qd. The time constant T is selected according to the sensor. The response compensation flow rate Qo is output to the first conversion table 54.

$$\begin{matrix}( Expression 1 ) & \\ \begin{matrix}Qo ( k ) = Δ Qo ( k ) + Qd ( k - 1 ) \\ = ( Qd ( k ) - Qd ( k - 1 ) ) \div ( 1 - {e}^{- ( Δ t / T )} ) + Qd ( k - 1 )\end{matrix} & ( 1 )\end{matrix}$$

The first conversion table 54 converts the output value compensated by the response compensation unit 72 into an air flow rate. In the present embodiment, the value converted in the first conversion table 54 may be referred to as a sampling value or an output value instead of the air flow rate. The first conversion table 54 is a conversion table that uses the flow rate output characteristic.

The amplitude reduction filter unit 73 is a functional block that is provided between the first conversion table 54 and the pulsation error correction unit 61, and to which an output value processed by the first conversion table 54 is input. The amplitude reduction filter unit 73 is a filter unit that blunts and reduces the pulsation amplitude Pa of the output value, and is formed by, for example, a low-pass filter. Processing of the amplitude reduction filter unit 73 is performed after processing of the first conversion table 54, and thus the average air amount Gave calculated using an output value, which will be described later, does not change.

As a functional block, the correction circuit 50 includes a second conversion table 74, a disturbance removal filter unit 75, a sampling number increasing unit 76, a switch unit 77, an upper extreme value determination unit 56, an average air amount calculation unit 57, a pulsation amplitude calculation unit 58, a frequency calculation unit 59, and a pulsation error calculation unit 60. Further, as a functional block, the correction circuit 50 includes a correction amount calculation unit 60a, a pulsation error correction unit 61, and a minus cut unit 78.

The correction circuit 50 has a first path 70a that inputs an output value converted in the first conversion table 54 to the pulsation amplitude calculation unit 58, and a second path 70b that inputs an output value before conversion in the first conversion table 54 to the pulsation amplitude calculation unit 58. In FIG. 7, an illustration of a part of the first path 70a is omitted by a symbol A.

The first path 70a is connected between the first conversion table 54 and the amplitude reduction filter unit 73, and the second path 70b is connected between the disturbance removal unit 71 and the response compensation unit 72.

Both of these paths 70a and 70b are connected to the pulsation amplitude calculation unit 58 via the switch unit 77. The switch unit 77 is a switching unit that selectively connects the first path 70a and the second path 70b to the pulsation amplitude calculation unit 58. When the switch unit 77 is in a first state, the pulsation amplitude calculation unit 58 is connected to the first path 70a but is blocked from the second path 70b. When the switch unit 77 is in a second state, the pulsation amplitude calculation unit 58 is connected to the second path 70b but is blocked from the first path 70a.

The switch unit 77 is set to one of the first state and the second state at the time of manufacturing the airflow meter 10, and basically holds the state after being mounted on the vehicle. The state of the switch unit 77 may be switched according to the engine operating state or the like after being mounted on the vehicle.

The second conversion table 74 is a functional block that is provided between the disturbance removal unit 71 and the switch unit 77 in the second path 70b, and to which an output value processed by the disturbance removal unit 71 is input. Unlike the first conversion table 54, the second conversion table 74 converts a sampling value acquired by the sampling unit 52 into an air flow rate at a stage before processing of the response compensation unit 72 is performed.

The disturbance removal filter unit 75 is a functional block that is provided between the second conversion table 74 and the sampling number increasing unit 76 in the path branched from the second path 70b, and to which an output value processed by the second conversion table 74 is input. The disturbance removal filter unit 75 is a filter unit that blunts and removes an output value contained in harmonic components that is a harmonic component, and is formed by, for example, a low-pass filter. The disturbance removal filter unit 75 can variably set a filter constant. The disturbance removal filter unit 75 corresponds to a low-pass filter unit that removes high frequency components included in the air flow rate value input from the sensing unit 22.

The sampling number increasing unit 76 is a functional block that is provided between the disturbance removal filter unit 75 and the upper extreme value determination unit 56, and to which an output value processed by the disturbance removal filter unit 75 is input. The sampling number increasing unit 76 is an up-sampling unit that increases the sampling value acquired by the sampling unit 52, and has a higher time resolution than the sampling unit 52. The sampling number increasing unit 76 is formed by a filter such as a variable filter or a CIC filter.

The upper extreme value determination unit 56 determines whether or not the sampling value processed by the sampling number increasing unit 76 is an upper extreme value Ea. The upper extreme value Ea is a sampling value at a time point when the output value switches from increasing to decreasing. The upper extreme value determination unit 56 acquires a time point when the sampling value has become the upper extreme value Ea as an upper extreme time point ta, and causes the time point to be stored in the storage device of the processing unit 45. The upper extreme value determination unit 56 outputs information including the upper extreme time point ta as timing information indicating a pulsation cycle to the average air amount calculation unit 57, the pulsation amplitude calculation unit 58, and the frequency calculation unit 59. In FIG. 7, an output of information related to the output value of the sensing unit 22 is illustrated by a solid line, and an output of the timing information is illustrated by a broken line.

The frequency calculation unit 59 uses the timing information from the upper extreme value determination unit 56 to calculate the interval at which the sampling value becomes the upper extreme value Ea as an upper extreme interval Wa, and uses this upper extreme interval Wa to calculate the pulsation frequency F. For example, as shown in FIG. 9, for a case where the sampling value becomes the upper extreme value Ea and then the sampling value becomes the next extreme value Ea, the previous extreme value Ea will be referred to as a first upper extreme value Ea1, and the next extreme value Ea will be referred to as a second upper extreme value Ea2. In this case, the frequency calculation unit 59 uses a first upper time point ta1 at which the sampling value becomes the first upper extreme value Ea1 and a second upper time point ta2 at which the sampling value becomes the second upper extreme value Ea2, and calculates the upper extreme interval Wa between the first upper extreme value Ea1 and the second upper extreme value Ea2. Then, the pulsation frequency F is calculated using the relationship F [Hz]=1/Wa [s], for example. The upper extreme interval Wa corresponds to a time interval.

For the period from the first upper time point ta1 to the second upper time point ta2, the maximum pulsation value Gmax (see FIG. 11), which is the maximum value of the air flow rate when the air is pulsating, is the first upper extreme value Ea1 and the second upper extreme value Ea2, whichever is larger. When these upper extreme values Ea1 and Ea2 are the same value, that value becomes the pulsation maximum value Gmax. The average value of the first upper extreme value Ea1 and the second upper extreme value Ea2 may be used as the pulsation maximum value Gmax.

Between the first upper extreme value Ea1 and the second upper extreme value Ea2, there is a lower extreme value Eb, which is a sampling value at a time point when the output value switches from decreasing to increasing. Since there is only one lower extreme value Eb between the first upper time point ta1 and the second upper time point ta2, this lower extreme value Eb becomes the pulsation minimum value Gmin (see FIG. 11).

The frequency calculation unit 59 adds the calculated pulsation frequency F to the pulsation error calculation unit 60, and outputs the calculated pulsation frequency F to the disturbance removal filter unit 75. The disturbance removal filter unit 75 feedback-controls an optimum filter constant using the pulsation frequency F from the frequency calculation unit 59.

The average air amount calculation unit 57 calculates an average air amount Gave (see FIG. 11), which is the average value of the air flow rate, by using sampling values converted in the first conversion table 54 and the timing information from the upper extreme value determination unit 56. The average air amount calculation unit 57 sets a target period for calculating the average air amount Gave, as a measurement period, using a determination result of the upper extreme value determination unit 56, and calculates the average air amount Gave for this measurement period. For example, in FIG. 9, when the period from the first upper extreme time point ta1 to the second upper extreme time point ta2 is set as the measurement period, the average air amount Gave is calculated for this measurement period.

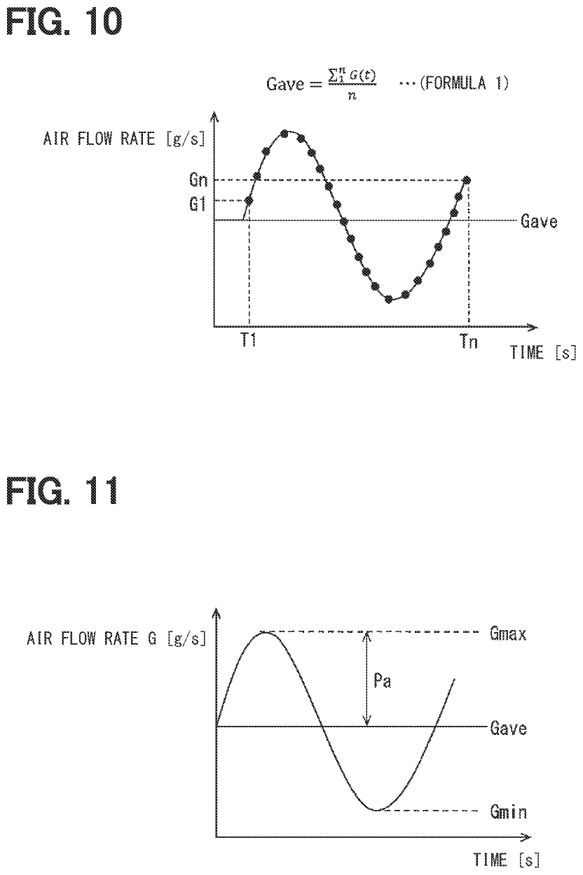

The average air amount calculation unit 57 calculates the average airflow Gave by using, for example, an integrated average. In this example, the calculation of the average air amount Gave will be described with reference to a waveform shown in FIG. 10. In this example, the measurement period is from a time point t1 to a time point tn, the air flow rate at the time point t1 is G1, and the air flow rate at the time point tn is Gn. The average air amount calculation unit 57 calculates the average airflow Gave by using Formula 1 in FIG. 10. In this case, when the number of samples is larger as compared with a case in which the number of samples is smaller, the average airflow Gave can be calculated in which an influence of the pulsation minimum Gmin whose detection accuracy is relatively lower is reduced.

In the measurement flow channel 32, if the actual air flow rate is sufficiently large, a streamline is less likely to fluctuate when air travels toward the measurement outlet 36, and it is conceivable that the traveling direction and flow rate of the air passing through the sensing unit 22 tend to be stable. Thus, detection accuracy of the sensing unit 22 tends to be high because the actual air flow rate is sufficiently large. On the other hand, as the actual air flow rate decreases, the traveling direction and flow rate of the air tends to be unstable. For example, when the actual air flow rate in the measurement flow channel 32 is the smallest in the range in which no backflow occurs, it is conceivable that the traveling direction and flow rate of the air are not stable because the air meanders while traveling toward the measurement outlet 36, or the like. Therefore, as the actual airflow rate decreases, the detection accuracy of the sensing unit 22 tends to decrease. Therefore, the detection accuracy of the sensing unit 22 is relatively low for the minimum pulsation value Gmin among the output values.

The pulsation amplitude calculation unit 58 calculates a pulsation amplitude Pa, which is the magnitude of the pulsation generated by the air flow rate, using the sampling value converted by the first conversion table 54 and the timing information from the upper extreme value determination unit 56. The pulsation amplitude calculation unit 58 targets the measurement period for calculation, and as shown in FIG. 11, calculates the pulsation amplitude Pa of the air flow rate by taking a difference between the maximum pulsation value Gmax and the average air amount Gave. In other words, the pulsation amplitude calculation unit 58 obtains not a total amplitude of the airflow but a half amplitude of the airflow. This is to reduce the influence of the pulsation minimum Gmin whose detection accuracy is relatively low as described above. The pulsation amplitude calculation unit 58 may calculate the total amplitude, which is a difference between the maximum pulsation value Gmax and the minimum pulsation value, as the pulsation amplitude.

Regarding the output value of the sensing unit 22, the upper extreme value Ea, the pulsation frequency F, the pulsation amplitude Pa, and the average air amount Gave indicate a pulsation state that is a state of pulsation, and correspond to the pulsation parameters. In this case, the upper extreme value determination unit 56, the average air amount calculation unit 57, the pulsation amplitude calculation unit 58, and the frequency calculation unit 59 correspond to a pulsation state calculation unit for calculating the pulsation state.

The pulsation error calculation unit 60 calculates the pulsation error Err of the airflow correlated with the pulsation amplitude Pa. The pulsation error calculation unit 60 predicts the pulsation error Err of the airflow by use of, for example, a map in which the pulsation amplitude Pa and the pulsation error Err are associated with each other. In other words, when the pulsation amplitude Pa is obtained by the pulsation amplitude calculation unit 58, the pulsation error calculation unit 60 extracts the pulsation error Err correlated with the obtained pulsation amplitude Pa from the map. It can also be said that the pulsation error calculation unit 60 acquires the pulsation error Err correlated with the pulsation amplitude Pa for the measurement period. The pulsation error calculation unit 60 corresponds to an error calculation.

The correction amount calculation unit 60a calculates the correction amount Q using the pulsation error Err calculated by the pulsation error calculation unit 60. The correction amount calculation unit 60a targets the measurement period for calculation, and calculates the correction amount Q by using the correlation information such as a map illustrating the correlation between the pulsation error Err and the correction amount Q. The correction amount Q is a value indicating the ratio of the correction to the output value. For example, when the output value is corrected so that the air flow rate becomes large, the correction amount Q becomes larger than 1, and when the output value is corrected so that the air flow rate becomes small, the correction amount Q becomes smaller than 1. The correction ratio can also be referred to as a gain.

The pulsation error correction unit 61 corrects the air flow rate so that the pulsation error Err becomes small by using the sampling value converted by the first conversion table 54 and the correction amount Q calculated by the correction amount calculation unit 60a. In other words, the pulsation error correction unit 61 corrects the airflow so that the airflow affected by the pulsation approaches the true airflow. In this example, the average air amount Gave is adopted as an object to be corrected for the air flow rate.

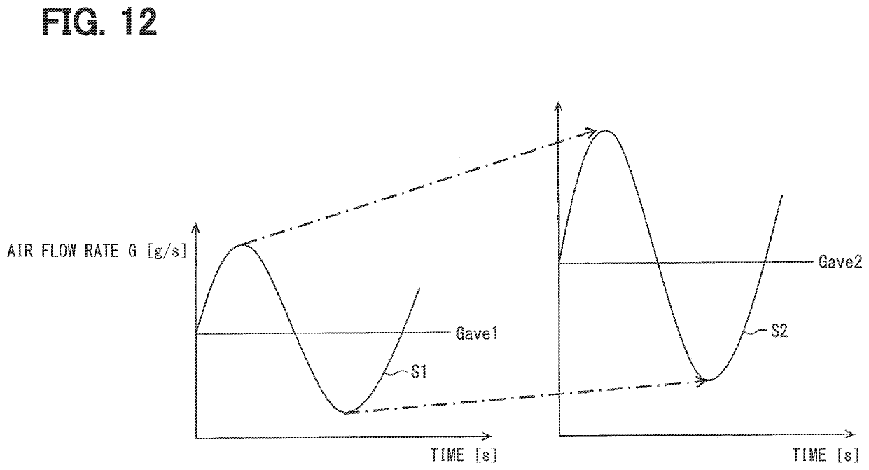

The pulsation error correction unit 61 corrects an output value S1 before correction with the correction amount Q and calculates the output value S2 after correction. In the present embodiment, the output value S2 after correction is calculated by multiplying the output value S1 before correction by the correction amount Q. In this case, the relationship S2=S1×Q is satisfied. For example, when the correction amount Q is larger than 1, the output value S2 after correction becomes larger than the output value S1 before correction, as shown in FIG. 12. The pulsation error correction unit 61 targets the measurement period for calculation, and the output value S1 before correction includes at least the upper extreme value Ea and the lower extreme value Eb. Regarding the air flow rate, the output value S2 after correction corresponds to a measurement result. In addition, the pulsation error correction unit 61 corresponds to a flow rate correction unit.

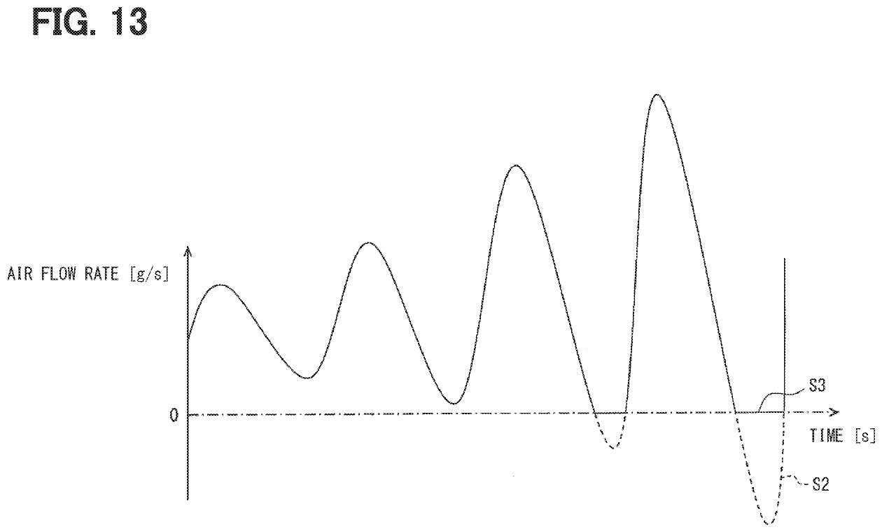

The minus cut unit 78 cuts a minus output value S2 out of the output value S2 after correction, and calculates an output value S3 after cutting. As shown in FIG. 13, when the output value S2 after correction includes a minus value, which is a negative value, the minus value is cut by the minus cut unit 78 to be zero, so that the output value S3 after cutting does not include any negative values. On the other hand, for a plus value, which is a positive value, the output value S2 after correction and the output value S3 after cutting are the same values. As described above, in the housing 21, the measurement outlet 36 is provided at a position where a backflow generated in the intake passage 12 is less likely to flow in from the measurement outlet 36, but when entrance of the backflow from the measurement outlet 36 does not always become zero. In this case, the air flow rate of the backflow entering from the measurement outlet 36 becomes unstable, and it becomes difficult to measure the air flow rate with high accuracy. Accordingly, by performing processing of the minus cut unit 78, the measurement accuracy of the air flow rate can be improved.

The correction circuit 50 outputs the output value S2 after correction calculated by the pulsation error correction unit 61 to the output circuit 62. The output circuit 62 outputs the output value S2 after correction to the ECU 46. In the correction circuit 50, in addition to the average air amount Gave2 after correction calculated by the pulsation error correction unit 61 and the output value

S2 after correction, the output value S3 after cutting calculated by the minus cut unit 78 is output to the output circuit 62. Then, the output circuit 62 outputs, to the ECU 46, the average air amount Gave2 after correction, the output value S2 after correction, and the output value S3 after cutting.

The ECU 46 uses the output value S2 after correction input from the output circuit 62 to calculate the average value of the output value S2 after correction as the average air amount Gave2 after correction. For example, when the correction amount Q is larger than 1, as shown in FIG. 12, the average air amount Gave2 after correction is larger than the average air amount Gavel after correction.

In the above configuration, the disturbance removal filter unit 75 is configured as an Infinite Impulse Response (IIR) filter having a feedback path inside, unlike a Finite Impulse Response (FIR) filter.

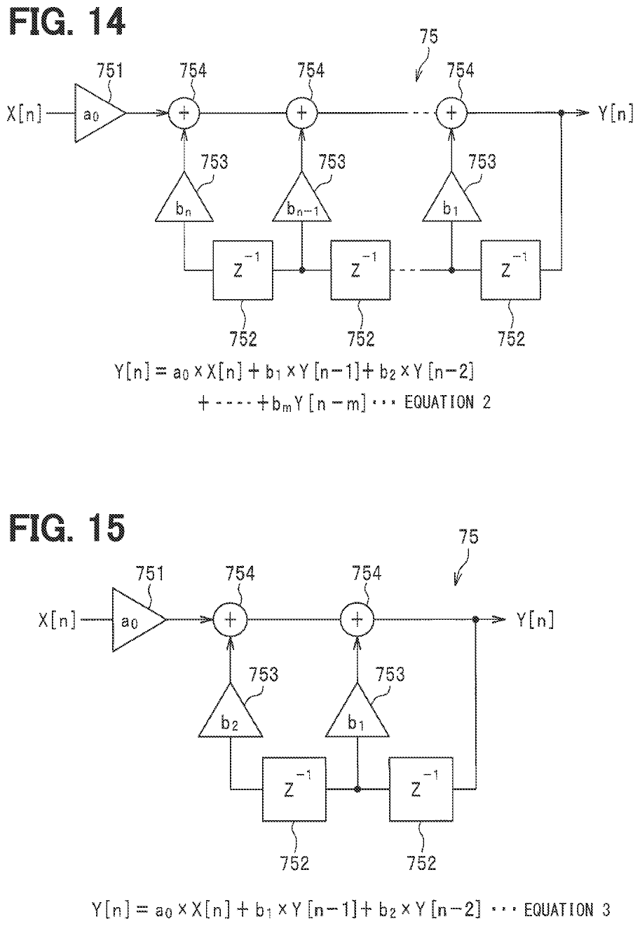

FIG. 14 shows a configuration of the disturbance removal filter unit 75 according to this embodiment. The disturbance removal filter unit 75 has a multiplier 751, a delay block 752, a multiplier 753 and an adder 754.

The multiplier 751 multiplies an input X[n] by a constant a0 and outputs the result. The constant a0 is the arbitrary number. Each delay block 752 delays the signal by one sample. The disturbance removal filter unit 75 of this embodiment has a plurality of delay blocks 752 connected in multiple stages. The multiplier 753 multiplies the input by bn, where bn is the feedback coefficient, and outputs the result. The adder 754 outputs the sum of the two input signals. Equation 2 in FIG. 14 is satisfied for the input and output of the disturbance removal filter unit 75 shown in FIG. 14.

The disturbance removal filter unit 75 is provided by a high-order recursive low-pass filter that includes the plurality of delay blocks 752 that delay the output signal output from the filter unit 75 by different delay amounts, and the adder 754 that adds a signal output from the plurality of delay blocks 752 to the input signal of the filter unit 75 by performing a feedback of the signal output from the plurality of delay blocks 752.

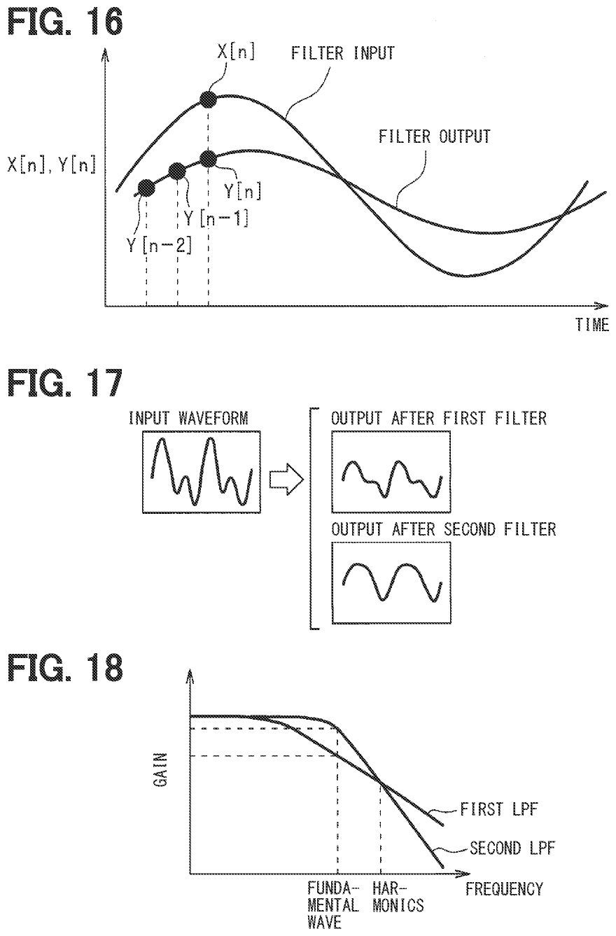

FIG. 15 shows the configuration of a secondary low-pass filter obtained by simplifying the disturbance removal filter unit 75 of this embodiment. Equation 3 in FIG. 15 is satisfied for this secondary low-pass filter. Further, this secondary low-pass filter has input/output characteristics as shown in FIG. 16.

FIG. 17 shows the relationship between the input waveform and the output waveform of the primary low-pass filter (not shown) as a comparative example, and the relationship between the input waveform and the output waveform of the secondary low-pass filter shown in FIG. 15. Since the primary low-pass filter of the comparative example cannot completely remove harmonics, the output waveform includes a steep part. On the other hand, the secondary low-pass filter shown in FIG. 15 can sufficiently remove harmonics, so that the entire output waveform has a gentle curve.

FIG. 18 shows the frequency characteristics of the primary low-pass filter as the comparative example and the secondary low-pass filter shown in FIG. 15. Since the primary low-pass filter of the comparative example attenuates the fundamental wave included in the input signal, the fundamental wave of the output signal of the flow rate detection unit during low pulsation cannot be detected with high accuracy and the measurement accuracy of the air flow rate deteriorates.

On the other hand, the secondary low-pass filter shown in FIG. 15 can attenuate harmonics without attenuating the fundamental wave included in the input signal.

In this configuration, the high-order low-pass filter can attenuate the harmonics without attenuating the fundamental wave included in the input signal. In addition, since the fundamental wave included in the input signal is not attenuated, the fundamental wave of the output signal of the flow rate detection unit can be detected accurately even during low pulsation, and the measurement accuracy of the air flow rate can be improved.

Further, the pulsation frequency F is notified from the frequency calculation unit 59 to the disturbance removal filter unit 75 of the present embodiment. The disturbance removal filter unit 75 has a function of changing the cutoff frequency according to the pulsation frequency F notified from the frequency calculation unit 59.

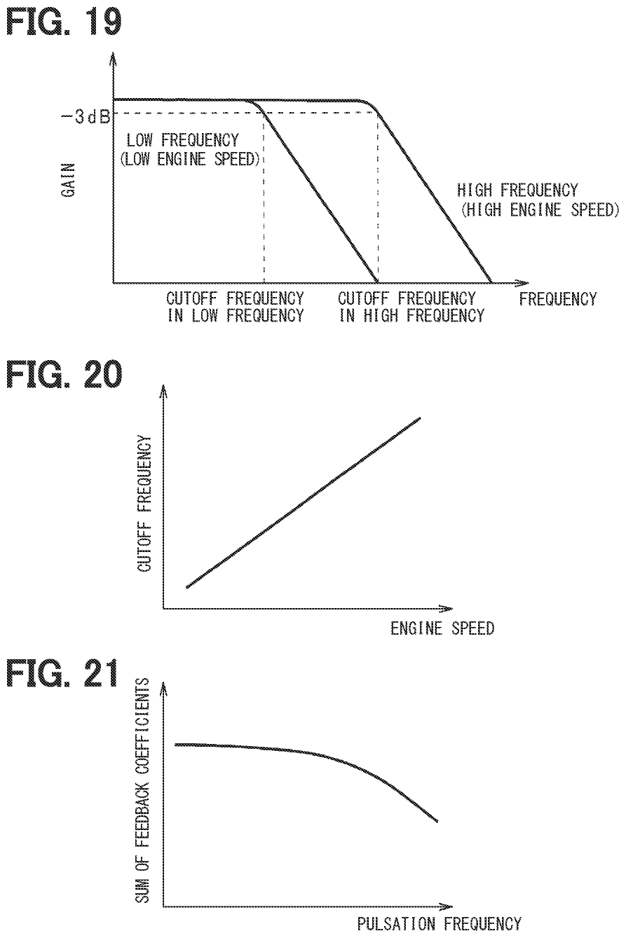

FIG. 19 shows the frequency characteristics of the disturbance removing filter unit 75 when the pulsation frequency F is low frequency and when the pulsation frequency F is high frequency. The disturbance removal filter unit 75 of this embodiment is configured such that the cutoff frequency changes according to the pulsation frequency F. Specifically, when the pulsation frequency F is low, the cutoff frequency is low, and when the pulsation frequency F is high, the cutoff frequency is also high.

FIG. 20 shows the relationship between the cutoff frequency of the disturbance removal filter unit 75 and the engine speed. The cutoff frequency of the disturbance removal filter unit 75 changes linearly with respect to the engine speed. Specifically, the cutoff frequency of the disturbance removal filter unit 75 increases as the engine speed increases. This configuration makes it possible to remove high frequency components according to the engine speed.

FIG. 21 shows the relationship between the sum of the feedback coefficients b1 to bm of the disturbance removal filter unit 75 and the pulsation frequency as shown in FIG. 21, in the disturbance removal filter unit 75, the sum of the feedback coefficients b1 to bm that are multiplied to values output from the plurality of delay blocks 752 becomes smaller as the pulsation frequency calculated by the frequency calculation unit 59 increases. More specifically, the sum of the feedback coefficients b1 to bm of the disturbance removal filter unit 75 is set to decrease monotonically as the pulsation frequency increases. Further, the change amount of the sum of the feedback coefficients b1to bm of the disturbance removing filter unit 75 increases as the pulsation frequency increases.

In this configuration, as the pulsation frequency calculated by the frequency calculation unit 59 increases, the sum of the feedback coefficients b1 to bm of the disturbance removal filter unit 75 is set to become monotonously smaller. As a result, the pulsation frequency becomes high as the cutoff frequency of the disturbance removal filter unit 75 increases.

Further, the disturbance removal filter unit 75 of this embodiment is set so as to remove components of a predetermined cutoff frequency or higher from the waveform of the sampling values. The cutoff frequency can be set to a positive real number multiple of the pulsation frequency calculated by the frequency calculation unit 59. This real number may or may not be an integer.

As described above, the measurement control device of the present embodiment includes the sensing unit 22 that outputs the air flow rate value corresponding to the air flow rate flowing through the flow path, and the disturbance removal filter unit 75 removes the high frequency components included in the air flow rate input from the sensing unit 22. The measurement control device of the present embodiment includes the pulsation state calculation unit that calculates a pulsation state that is a state of the pulsation occurring in the air flow rate based on the air flow rate value that has passed through the disturbance removal filter unit 75. The measurement control device includes the pulsation error correction unit 61 that corrects the air flow rate value using the pulsation state calculated by the pulsation state calculation unit. The disturbance removal filter unit 75 is provided by a high-order recursive low-pass filter that includes the plurality of delay blocks 752 that delay the output signal by different delay amounts, and the adder 754 that adds a signal output from the plurality of delay blocks 752 to the air flow rate value by performing a feedback of the signal output from the plurality of delay blocks 752.

In this configuration, a high-order recursive low-pass filter that includes the plurality of delay blocks 752 that delay the output signal by different delay amounts, and the adder 754 that adds a signal output from the plurality of delay blocks 752 to the airflow rate value by performing a feedback of the signal output from the plurality of delay blocks 752 is provided. Therefore, high-order harmonic components can be sufficiently removed, the attenuation of the fundamental wave output from the sensing unit can be reduced, and the measurement accuracy of the air flow rate can be improved.

Further, the pulsation state calculation unit includes the upper extreme value determination unit 56 that determines whether or not the air flow rate value becomes the upper extreme value Ea that is a value when the air flow rate value changes from increasing to decreasing. Further, the pulsation state calculation unit includes the frequency calculation unit 59 that calculates the pulsation frequency using the time interval Wa between the time point ta1 when the airflow rate value becomes the upper extreme value Ea and the next time point ta2 when the air flow rate value becomes the upper extreme value Ea next time.

Thus, the pulsation frequency can be calculated using the time interval Wa between the time point ta1 when the air flow rate value becomes the upper extreme value Ea and the next time point ta2 when the air flow rate value becomes the upper extreme value Ea next time.

The disturbance removal filter unit 75 also removes frequency components equal to or higher than a predetermined cutoff frequency, and the cutoff frequency is set to increase as the pulsation frequency calculated by the frequency calculation unit 59 increases.

Therefore, the cutoff frequency can be variably set according to the frequency of the harmonic noise generated by the change in the engine rotation speed. In addition, it is possible to sufficiently remove harmonic components that increase as the engine speed increases. Therefore, it is possible to further improve the measurement accuracy of the air flow rate.

In the disturbance removal filter unit 75, the sum of the feedback coefficients b1 to bm that are multiplied to values output from the plurality of delay blocks 752 becomes smaller as the pulsation frequency calculated by the frequency calculation unit 59 increases.

As a result, the cutoff frequency can increase as the pulsation frequency calculated by the frequency calculation unit 59 increases.

The pulsation state calculation unit also has the average air amount calculation unit 57 that calculates the average air amount Gave, which is the average of the air flow rate, based on the air flow rate value. The pulsation state calculation unit also has the pulsation amplitude calculation unit 58 that calculates the pulsation amplitude Pa, which is the amplitude of pulsation generated in the air flow rate, using the pulsation frequency calculated by the frequency calculation unit.

The measurement control device also includes the response compensation unit 72 that advances the phase of the air flow rate value to compensate for the response delay of the air flow rate value. Therefore, it is possible to obtain the air flow rate value before the response delay of the air flow rate value.

Further, the response compensation unit 72 calculates so that the amount of change in the air flow rate value with respect to the time change increases.

Further, the measurement control device includes the variation adjustment unit 53 that is arranged between the sensing unit 22 and the disturbance removing filter unit 75, and adjusts the variation of the air flow rate value of the sensing unit 22. As a result, variations in measured values caused by individual differences in measurement control devices can be suppressed.

### Second Embodiment

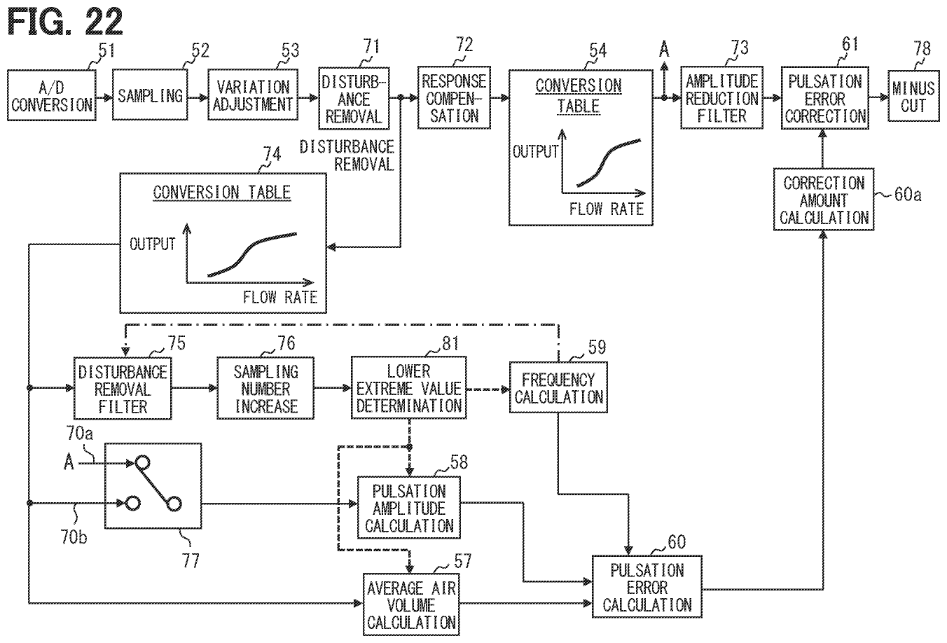

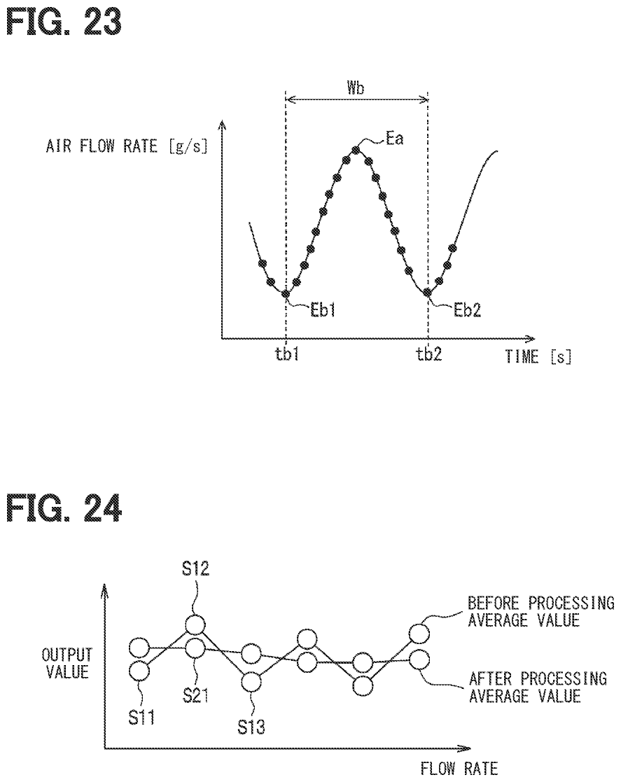

A measurement control device according to a second embodiment will be described with reference to FIGS. 22 to 23. In the first embodiment, the correction circuit 50 includes the upper extremum value determination unit 56, but in the present embodiment, the correction circuit 50 includes a lower extremum value determination unit 81 instead of the upper extremum value determination unit 56.

As shown in FIG. 22, the lower extreme value determination unit 81 is provided between the conversion table 54 and the frequency calculation unit 59 in the correction circuit 50. The lower extreme value determination unit 81 determines whether or not a sampling value processed by the conversion table 54 is a lower extreme value Eb. As described above, the lower extreme value Eb is the sampling value at a time point when an output value switches from decreasing to increasing. The lower extreme value determination unit 81 acquires a time point when the sampling value becomes the lower extreme value Eb as the lower extreme time point tb, and causes the lower extreme value Eb to be stored in the storage device of the processing unit 45. The lower extreme value determination unit 81 outputs information including the lower extreme time point tb as timing information indicating a pulsation cycle to the average air amount calculation unit 57, the pulsation amplitude calculation unit 58, and the frequency calculation unit 59.

The frequency calculation unit 59 uses the timing information from the lower extreme value determination unit 81 to calculate an interval at which the sampling value becomes the lower extreme value Eb as a lower extreme interval Wb, and uses this lower extreme interval Wb to calculate the pulsation frequency F. For example, as shown in FIG. 23, for a case where the sampling value becomes the lower extreme value Eb and then the sampling value becomes the next extreme value Eb, the previous lower extreme value Eb will be referred to as a first lower extreme value Eb1, and the next lower extreme value Eb will be referred to as a second lower extreme value Eb2. In this case, the frequency calculation unit 59 uses a first lower time point tb1 at which the sampling value becomes the first lower extreme value Eb1 and a second lower time point ta2 at which the sampling value becomes the second lower extreme value Ea2, and calculates the lower extreme interval Wb between the first lower extreme value Eb1 and the second lower extreme value Eb2. Then, the pulsation frequency F is calculated using the relationship F [Hz]=1/Wb [s], for example.

As described above, the pulsation state calculation unit includes the lower extreme value determination unit 81 that determines whether or not the air flow rate value becomes the lower extreme value Eb that is a value when the air flow rate value changes from decreasing to increasing. Further, the pulsation state calculation unit includes the frequency calculation unit 59 that calculates the pulsation frequency using the time interval Wb between the time point tb1 when the air flow rate value becomes the lower extreme value Eb and the next time point tb2 when the air flow rate value becomes the lower extreme value Eb next time.

Thus, the pulsation frequency can be calculated using the time interval Wb between the time point ta1 when the air flow rate value becomes the upper extreme value Ea and the next time point ta2 when the air flow rate value becomes the upper extreme value Ea next time.

### Third Embodiment

A measurement control device according to a third embodiment will be described. In the measurement control device of the present embodiment, the frequency calculation unit 59 performs average value processing for outputting an average pulsation frequency that is an average of the pulsation frequencies in the measurement period, as the pulsation frequency. For example, as shown in FIG. 24, the average of the sample values S11, S12, and S13 is output as the pulsation frequency average value S21.

Further, in the measurement control device of the present embodiment, the pulsation amplitude calculation unit 58 performs average value processing for outputting a pulsation amplitude average value that is an average of the pulsation amplitudes in the measurement period, as the pulsation amplitude. Furthermore, the average air amount calculation unit 57 performs average value processing for outputting an average air flow rate average value that is an average of the average air flow rates in the measurement period, as the average air flow rate.

The measurement control device includes the pulsation error calculation unit 60 that calculates the pulsation error Err that is an error that occurs in the air flow rate due to pulsation included in the air flow rate value. Then, the pulsation state calculation unit outputs the average value of each of the pulsation frequency, the pulsation amplitude, and the average air amount to the pulsation error calculation unit 60.

By outputting the average values of the pulsation frequency, the pulsation amplitude, and the average air amount to the pulsation error calculation unit 60, robustness against minute variations in the pulsation frequency, the pulsation amplitude, and the average air amount can be improved. Influence of variation on the output value of the sensing unit 22 can be mitigated.

In this embodiment, the pulsation state calculation unit outputs the average values of the pulsation frequency, the pulsation amplitude, and the average air amount to the pulsation error calculation unit 60. Alternatively, at least one of the average values of the pulsation frequency, the pulsation amplitude, and the average air amount may be output to the pulsation error calculation unit 60.

### Fourth Embodiment

A measurement control device according to a fourth embodiment will be described. In the measurement control device of the present embodiment, the frequency calculation unit 59 performs median processing for calculating a median pulsation frequency that is a median value of the pulsation frequency in the measurement period.

Further, in the measurement control device of the present embodiment, the pulsation amplitude calculation unit 58 performs median processing for outputting a median value of the pulsation amplitude in the measurement period as the pulsation amplitude. Further, the average air amount calculation unit 57 performs median processing for outputting a median value of the average airflow rate in the measurement period as the average air flow rate.

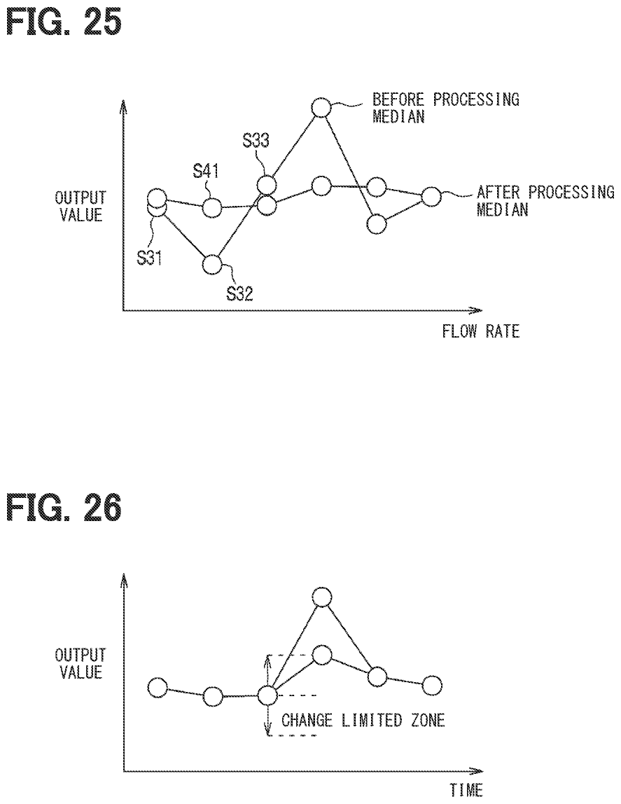

In the median value processing, as shown in FIG. 25, for example, when three pulsation frequencies S31, S32, and S33 are calculated in the measurement period, the median value S31 excluding the maximum value S33 and the minimum value S32 is calculated, and the median value S31 is output as the median pulsation frequency S41.

By outputting the median values of the pulsation frequency, the pulsation amplitude, and the average air amount to the pulsation error calculation unit 60, robustness against minute variations in the pulsation frequency, the pulsation amplitude, and the average air amount can be improved. In addition, the influence of instantaneously generated noise on the output value of the sensing unit 22 can be mitigated.

In this embodiment, the pulsation state calculation unit outputs the median values of the pulsation frequency, the pulsation amplitude, and the average air amount to the pulsation error calculation unit 60. Alternatively, at least one of the median values of the pulsation frequency, the pulsation amplitude, and the average air amount may be output to the pulsation error calculation unit 60.

### Fifth Embodiment

A measurement control device according to a fifth embodiment will be described. In the measurement control device of the present embodiment, the pulsation state calculation unit has a limiting function that, when difference between a present value and a previous value for each of the pulsation frequency, the pulsation amplitude, and the average air amount is equal to or larger than a certain value, makes a negative determination on the present value and limits the difference within the certain value. Therefore, the configuration can limit the change amount between the pulsation frequency calculated this time and the pulsation frequency calculated last time to less than the certain value, and the influence of momentary noise can be reduced.

Further, the measurement control device further includes a receiver 63 that receives a signal instructing whether the limiting function is valid or invalid. Thereby, it is possible to switch between valid and invalid of the limiting function.

### Other Embodiments

Although a plurality of embodiments according to the present disclosure have been described above, the present disclosure is not construed as being limited to the embodiments described above, and can be applied to various embodiments and combinations within a scope not departing from the spirit of the present disclosure.

(1) The processing unit 45 may process the output value from the sensing unit 22 by a map, a function, a fast Fourier transform (FFT), or the like to calculate the pulsation frequency F.

(2) The function achieved by the processing unit 45 may be achieved by hardware and software, or a combination thereof. The processing unit 45 may communicate with, for example, another control device, such as the ECU 46, and the other control device may perform some or all of the processing. The processing unit 45, when implemented by an electronic circuit, can be implemented by a digital circuit including a large number of logic circuits, or an analog circuit.

The present disclosure is not limited to the above-described embodiments, and can be appropriately modified. Individual elements or features of a particular embodiment are generally not limited to that particular embodiment, but, where applicable, are interchangeable and can be used in a selected embodiment, even if not specifically shown or described. The constituent element(s) of each of the above embodiments is/are not necessarily essential unless it is specifically stated that the constituent element(s) is/are essential in the above embodiment, or unless the constituent element(s) is/are obviously essential in principle. Further, in each of the above-described embodiments, when numerical values such as the number, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Furthermore, a material, a shape, a positional relationship, or the like, if specified in the above-described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

Each of the upper extreme value determination unit 56, the average air amount calculation unit 57, the pulsation amplitude calculation unit 58, the frequency calculation unit 59, and the lower extreme value determination unit 81 corresponds to a pulsation state calculation unit. In addition, the pulsation error correction unit 61 corresponds to a flow rate correction unit, and the disturbance removing filter unit 75 corresponds to a low-pass filter.

What is claimed is:

1. A measurement control device comprising:
a sensing unit configured to output an air flow rate value corresponding to an air flow rate flowing through a flow path;
a low-pass filter unit configured to remove high-frequency components included in the air flow rate value input from the sensing unit;
a pulsation state calculation unit configured to calculate a pulsation state that is a state of a pulsation occurring in the air flow rate based on the air flow rate value that has passed through the low-pass filter unit; and
a flow rate correction unit configured to correct the air flow rate value using the pulsation state calculated by the pulsation state calculation unit, wherein
the low-pass filter unit includes a high-order recursive low-pass filter that includes:
a plurality of delay blocks configured to delay an output signal output from the low-pass filter unit by different delay amounts; and
an adder configured to add signals output from the plurality of delay blocks to the airflow rate value corresponding to the airflow rate input from the sensing unit by performing a feedback of the signals output from the plurality of delay blocks.

2. The measurement control device according to claim 1, wherein
the pulsation state calculation unit includes:
an upper extreme value determination unit configured to determine whether the air flow rate value becomes an upper extreme value that is a value when the air flow rate value changes from increasing to decreasing; and
a frequency calculation unit configured to calculate a pulsation frequency using a time interval between a time point when the air flow rate value becomes the upper extreme value and a next time point when the air flow rate value becomes the upper extreme value next time.

3. The measurement control device according to claim 1, wherein
the pulsation state calculation unit includes:
an lower extreme value determination unit configured to determine whether the air flow rate value becomes a lower extreme value that is a value when the air flow rate value changes from decreasing to increasing; and
a frequency calculation unit configured to calculate a pulsation frequency using a time interval between a time point when the air flow rate value becomes the lower extreme value and a next time point when the air flow rate value becomes the lower extreme value next time.

4. The measurement control device according to claim 2, wherein
the low-pass filter unit removes frequency components equal to or higher than a predetermined cutoff frequency, and
the predetermined cutoff frequency increases as the pulsation frequency calculated by the frequency calculation unit increases.

5. The measurement control device according to claim 2, wherein,
in the low-pass filter unit, a sum of feedback coefficients each of which is multiplied to a value output from a corresponding one of the plurality of delay blocks decreases as the pulsation frequency calculated by the frequency calculation unit increases.

6. The measurement control device according to claim 2, wherein
the pulsation state calculation unit further includes:
an average air amount calculation unit configured to calculate, based on the air flow rate value, an average air amount that is an average of the air flow rate; and
a pulsation amplitude calculation unit configured to calculate, using the pulsation frequency calculated by the frequency calculation unit, a pulsation amplitude that is an amplitude of the pulsation occurring in the air flow rate.

7. The measurement control device according to claim 6, further comprising
a pulsation error calculation unit configured to calculate a pulsation error that is an error that occurs in the air flow rate due to the pulsation occurring in the air flow rate value, wherein
the pulsation state calculation unit outputs at least one of average values of the pulsation frequency, the pulsation amplitude, and the average air amount to the pulsation error calculation unit.

8. The measurement control device according to claim 6, further comprising
a pulsation error calculation unit configured to calculate a pulsation error that is an error that occurs in the air flow rate due to pulsation in the air flow rate value, wherein
the pulsation state calculation unit outputs at least one of median values of the pulsation frequency, the pulsation amplitude, and the average air amount to the pulsation error calculation unit.

9. The measurement control device according to claim 6, wherein
the pulsation state calculation unit has a limiting function that, when a difference between a present value and a previous value for each of the pulsation frequency, the pulsation amplitude, and the average air amount is equal to or larger than a certain value, makes a negative determination on the present value and limits the difference within the certain value.

10. The measurement control device according to claim 9, further comprising
a receiver configured to receive a signal indicating whether the limiting function is valid or invalid.

11. The measurement control device according to claim 1, further comprising
a response compensation unit configured to advance a phase of the air flow rate value to compensate for a response delay of the air flow rate value.

12. The measurement control device according to claim 11, wherein
the response compensation unit performs a calculation such that an amount of change in the air flow rate value over time increases.

13. The measurement control device according to claim 1, further comprising
a variation adjustment unit disposed between the sensing unit and the low-pass filter unit, and configured to adjust a variation in the air flow rate value of the sensing unit.

14. A measurement control device comprising:
a sensor configured to output an air flow rate value corresponding to an air flow rate flowing through a flow path; and
a correction circuit that includes a low low-pass filter configured to remove high-frequency components included in the air flow rate value input from the sensor, wherein
the correction circuit calculates a pulsation state that is a state of a pulsation occurring in the air flow rate based on the air flow rate value that has passed through the low-pass filter, and corrects the air flow rate value using the pulsation state, and
the low low-pass filter is provided by a high-order recursive low-pass filter configured to:
delay an output signal output from the low-pass filter by different delay amounts; and
add signals delayed to the air flow rate value input from the sensor by performing a feedback of the signals delayed.
